(19) United States
(12) Patent Application Publication
(10) Pub. No.: US 2005/0179797 A1
(43) Pub. Date: Aug. 18, 2005

(54) Image capture device, method of controlling image capture device, and control program product of image capture device

(75) Inventor: Yoshihito Higashitsutsumi, Mizuho-shi (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 11/056,912

(22) Filed: Feb. 10, 2005

(30) Foreign Application Priority Data
Feb. 12, 2004 (JP) 2004-35536

(51) Int. Cl. H04N 5/335

(52) U.S. Cl. 348/311

(57) ABSTRACT

An image capture device comprises a solid image capture element that includes pixels, which generate and store information charges corresponding to the intensity of light made incident to the pixels during image capture, in which the pixels are provided with transfer electrodes, and the element transfers the information charges by applying voltage to the transfer electrodes during transfer and outputs the charges as image signals corresponding to the charge quantity, in which the image signals that have been output from the solid image capture element are processed in an analog front end circuit (AFE circuit) and a digital signal processing circuit (DSP circuit), and voltage applied to the transfer electrodes is changed by using a timing control circuit and a driver.

### CROSS-REFERENCE TO RELATED APPLICATION

The entire disclosure of Japanese Patent Application No.2004-35536 including specification, claims, drawings, and abstract is incorporated herein by reference.

### BACKGROUND OF THE INVENTION

1. Field of the Invention

The present invention relates to an image capture device, a method of controlling an image capture device, and a control program product of an image capture device, by which the picture quality of video signals is improved.

2. Description of the Related Art

A CCD (Charge Coupled Device) solid image capture element is a charge transfer element capable of moving information charges in a lump of packets in one direction at a speed synchronous with external clock pulse in good order.

FIG. 6 shows the constitution of an image capture device 100 provided with a CCD solid image capture element. The image capture device 100 comprises a CCD solid image capture element 102, a timing control circuit 104, and a driver 106. The CCD solid image capture element 102 has an image capture section 2i, a storage section 2s, a horizontal transfer section 2h, and an output section 2d. The image capture section 2i and the storage section 2s include vertical shift registers made up of a plurality of channel regions extending in parallel with each other in the vertical direction (longitudinal directions of FIG. 6), and a plurality of transfer electrodes that cross the channel regions. Each bit of each shift register functions as one light-receiving pixel that is arranged in a two-dimensional matrix. The vertical shift register included in the storage section is shielded from light, and each bit of each shift register functions as a storage pixel that stores information charges. The horizontal transfer section 2h includes a horizontal shift register that is arranged extending in horizontal directions (horizontal directions of FIG. 6). The output of each shift register of the storage section 2s is connected to each bit of the horizontal shift register. The output section 2d includes a capacitor that temporarily stores charges, which are transferred from the horizontal shift register of the horizontal transfer section 2h, and a reset transistor that discharges the charges stored in the capacitor.

The timing control circuit 104 receives external control signals and a clock pulse of a predetermined frequency, and generates control signals that control the image capture, the vertical transfer, the horizontal transfer, and the output of the CCD solid image capture element 102. The control signals are input to the driver 106. The driver 106 receives the control signals from the timing control circuit 104 and outputs clock signals severally to the image capture section 2i, the storage section 2s, the horizontal transfer section 2h, and the output section 2d of the CCD solid image capture element 102 at an appropriate timing.

The CCD solid image capture element 102 receives the clock from the driver 106 and performs image capture, vertical transfer, horizontal transfer, and output. Photoelectric conversion is performed to light, which has been made incident to the image capture section 2i, by the light-receiving pixel constituting each bit of the image capture section 2i, and the information charges are stored. By applying vertical transfer clock, the vertical shift register of the image capture section 2i transfers the two-dimensional array of the information charges stored in the image capture section 2i to the storage section 2s at high speed. Thus, the information charges equivalent to one frame are held in the vertical shift register of the storage section 2s. Subsequently, the information charges are transferred from the storage section 2s to the horizontal transfer section 2h by the quantity of one row. Further, by applying a horizontal transfer clock, the information charges are transferred from the horizontal transfer section 2h to the output section 2d in one pixel unit. The output section 2d converts the charge quantity by one pixel into a voltage value, and the voltage value is used as the output from a CCD.

When an image capture device including a CCD solid image capture element stores information charges during an exposure period, a technology called an AGP (All Gate Pinning) is known where negative voltage is applied to all transfer electrodes to turn them off. In the AGP, positive holes gather closer to a substrate surface of a transfer channel region and the energy level of its vicinity region becomes a pinning state. The positive holes fill an interface state density that occurs on the interface between a transfer channel region and a gate insulating film formed on a substrate surface, and dark current generated in an exposure period can be reduced.

However, when the AGP is applied, there is a problem that the capacitance of a potential well for storing the information charges during the exposure period becomes small. Therefore, when intense light radiated from a very bright object strikes the image capture section 2i, the quantity of information charges generated can exceed the saturation level of the potential well formed in each pixel, and thus the dynamic range of an obtained image is reduced. As a result, there has been a problem that the quality of image negatively affected.

### SUMMARY OF THE INVENTION

The present invention provides an image capture device comprising a solid image capture element that includes pixels, which generate and store information charges corresponding to the intensity of light made incident to the pixels during image capture period, in which the pixels are provided with transfer electrodes, and the element transfers the information charges by applying voltage to the transfer electrodes during transfer period and outputs the charges as image signals corresponding to the charge quantity, and the element includes voltage control means for changing voltage to be applied to the transfer electrodes corresponding to the intensity of light made incident to the pixels to change a saturation level of charges storable in the pixels during image capture.

The present invention also provides a method of controlling an image capture device comprising a solid image capture element that includes pixels, which generate and store information charges corresponding to the intensity of light made incident to the pixels during image capture period, in which the pixels are provided with transfer electrodes, and the element transfers the information charges by applying voltage to the transfer electrodes during transfer period and outputs the charges as image signals corresponding to the charge quantity, in which the method includes the step of control voltage where voltage to be applied to the transfer electrodes is changed corresponding to the intensity of light made incident to the pixels and a saturation level of charges storable in the pixels during image capture is changed.

The present invention further provides a control program product for a computer, which controls an image capture device that comprises a solid image capture element that includes pixels, which generate and store information charges corresponding to the intensity of light made incident to the pixels during image capture, in which the pixels are provided with transfer electrodes, and the element transfers the information charges by applying voltage to the transfer electrodes during transfer and outputs the charges as image signals corresponding to the charge quantity. This control program product allows the computer to function as voltage control means for changing voltage to be applied to the transfer electrodes corresponding to the intensity of light made incident to the pixels, and to function as a device for changing a saturation level of charges storable in the pixels during image capture.

### BRIEF DESCRIPTION OF THE DRAWINGS

Preferred embodiments of the present invention will be described in further detail based on the following drawings, wherein:

FIG. 1 is a block diagram of an image capture device in an embodiment of the present invention;

FIG. 2 is a timing chart explaining a method of controlling an image capture element and the potential of an image capture section;

FIG. 3 is a view illustrating the relationship between an OFF-gate period and an ON-gate period in the embodiment of the present invention;

FIG. 4 is a view illustrating the storage of information charges during an image capture period in the embodiment of the present invention;

FIG. 5 is a view illustrating the storage of information charges during an image capture period in the embodiment of the present invention; and

FIG. 6 is a block diagram showing the constitution of a conventional image capture device.

### DESCRIPTION OF THE PREFERRED EMBODIMENT

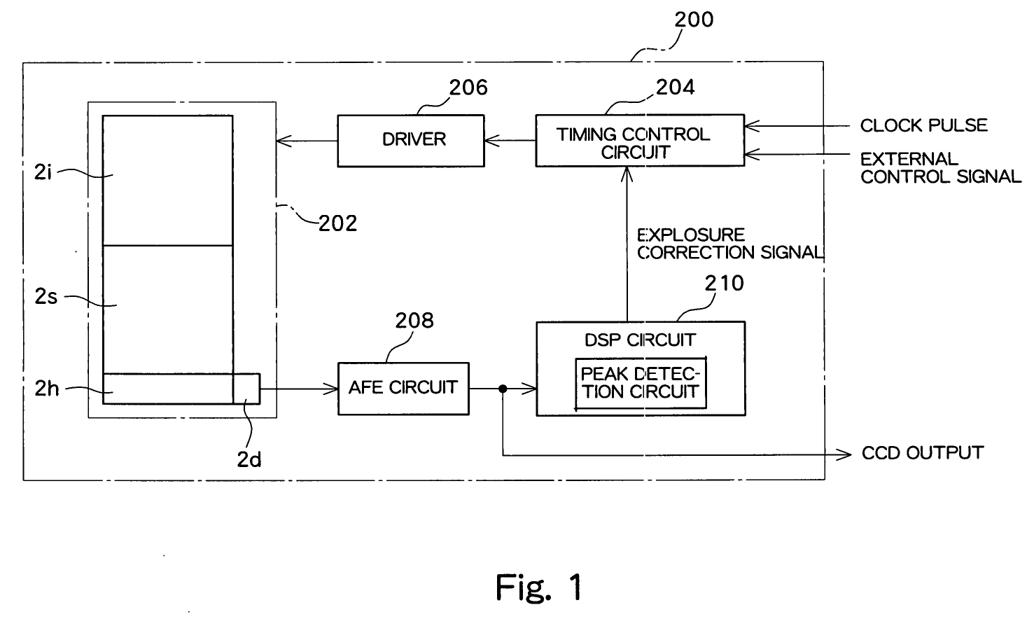

An image capture device 200 of a preferred embodiment of the present invention includes a CCD solid image capture element 202, a timing control circuit 204, a driver 206, an analog front end circuit (AFE circuit) 208, and a digital signal processing circuit (DSP circuit) 210, as shown in FIG. 1.

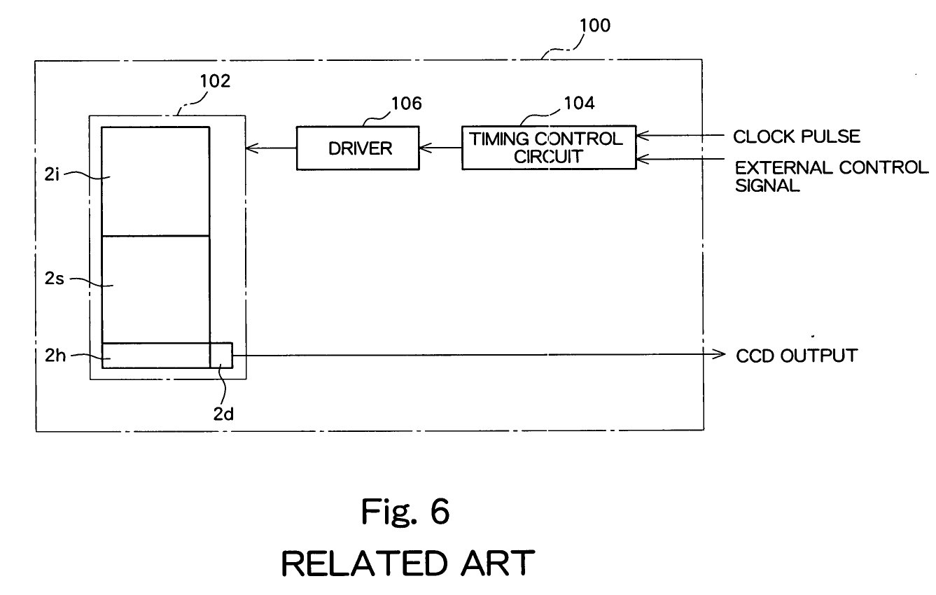

The CCD solid image capture element 202 comprises an image capture section 2i, a storage section 2s, a horizontal transfer section 2h, and an output section 2d, similar to the components of a conventional CCD solid image capture element as shown in FIG. 6. The configuration of the image capture section 2i, the storage section 2s, the horizontal transfer section 2h, and the output section 2d is the same as in the related art. The timing control circuit 204, the driver 206, the AFE circuit 208, and the DSP circuit 210 are combined to function as voltage control means, which controls transfer clock to be applied to the transfer electrodes of the solid image capture element, and image signal processing means, which performs processing such as smear removal to the image signals.

The timing control circuit 204 receives clock pulse of a predetermined frequency, external control signals, and exposure correction signals from the DSP circuit 210, and generates control signals for controlling the CCD solid image capture element 202. The control signals are input to the driver 206. The driver outputs clock signals to the image capture section 2i, the storage section 2s, the horizontal transfer section 2h, and the output section 2d at a required timing.

The CCD solid image capture element 202 receives the clock from the driver 206, and performs image capture, vertical transfer, horizontal transfer, and output. During image capture, the driver 206 controls the image capture section 2i by the vertical transfer clock, photoelectric conversion is performed to light, which has been made incident to the image capture section 2i, by the light-receiving pixel constituting each bit of the image capture section 2i, and the information charges are stored. During the vertical transfer period, the vertical shift register of the image capture section 2i transfers the two-dimensional array of the information charges stored in the image capture section 2i to the storage section 2s at high speed by the vertical transfer clock from the driver 206. Thus, information charges equivalent to one frame are held in the vertical shift register of the storage section 2s. Subsequently, the information charges are transferred from the storage section 2s to the horizontal transfer section 2h by the quantity of one row. Further, the information charges are transferred from the horizontal transfer section 2h to the output section 2d in one pixel unit by the horizontal transfer clock from the driver 206. The output section 2d converts the charge quantity by one pixel into a voltage value, and the changes of the voltage value are used as the output from the CCD.

The output signals from the CCD solid image capture element 202 are input to the AFE circuit 208. In the AFE circuit 208, conversion from analog signals to digital signals is performed by an A/D converter or the like after processing such as amplification and noise canceling has been performed to the output voltage of the CCD solid image capture element 202. The output signals from the AFE circuit 208 are input to the DSP circuit 210. The DSP circuit 210 comprises a peak detection circuit for image signals. The peak detection circuit sequentially compares the intensity of the image signals equivalent to one frame and calculates the maximum signal intensity from the image signals of one frame. Then, the circuit outputs exposure correction signals that are used for controlling the exposure in the CCD solid image capture element 202 to the timing control circuit 204 according to the maximum signal intensity of the image signals.

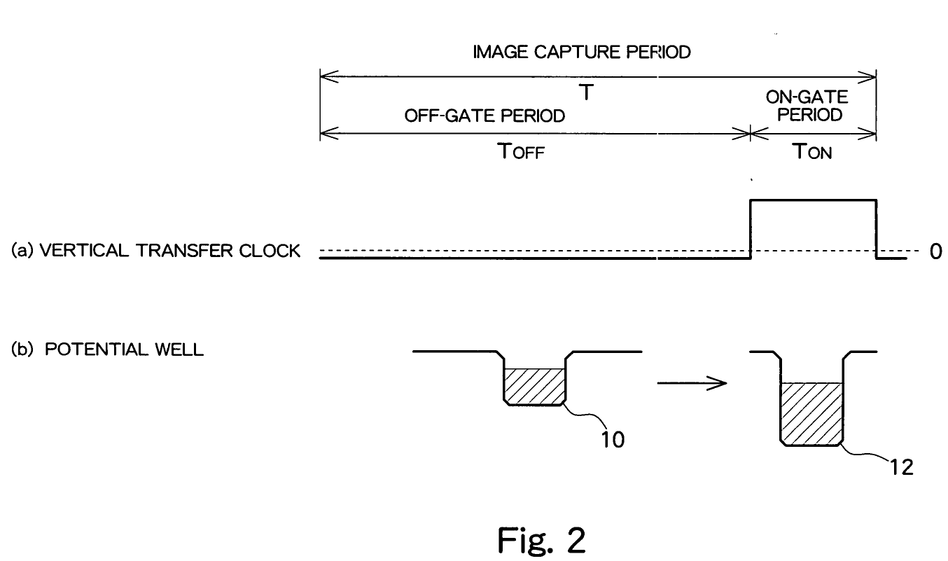

In the following, control during image capture will be described. In this embodiment, a voltage to be applied to the transfer electrodes corresponding to the intensity of light incident on the pixels is changed, as is the saturation level of charges storable in the pixels during image capture. The timing control circuit 204 controls an image capture period T in the image capture section 2i of the CCD solid image capture element 202 by dividing it into an OFF-gate period T_{OFF} and an ON-gate period T_{ON} as shown in FIG. 2. Negative voltage is applied to all transfer electrodes of the image capture section 2i during the OFF-gate period T_{OFF} as in FIG. 2(a). Therefore, each pixel of the image picture section 2i is in an OFF state in the OFF-gate period T_{OFF} and the information charges are stored while the dark current is suppressed by AGP (All Gate Pinning). A positive voltage is applied to a part of the transfer electrodes of the image capture section 2i during the ON-gate period T_{ON} as in FIG. 2(a). As a result, a potential well 12 deeper than a potential well 10 formed in the OFF-gate period T_{OFF} is formed in the ON-gate period T_{ON} as shown in FIG. 2(b). Accordingly, the saturation level of storable information charges in the ON-gate period T_{ON} becomes larger than that in the OFF-gate period T_{OFF}. However, the energy level of a transfer channel region of the image capture section 2i is not in a pinning in the ON-gate period T_{ON} and is easily affected by the dark current.

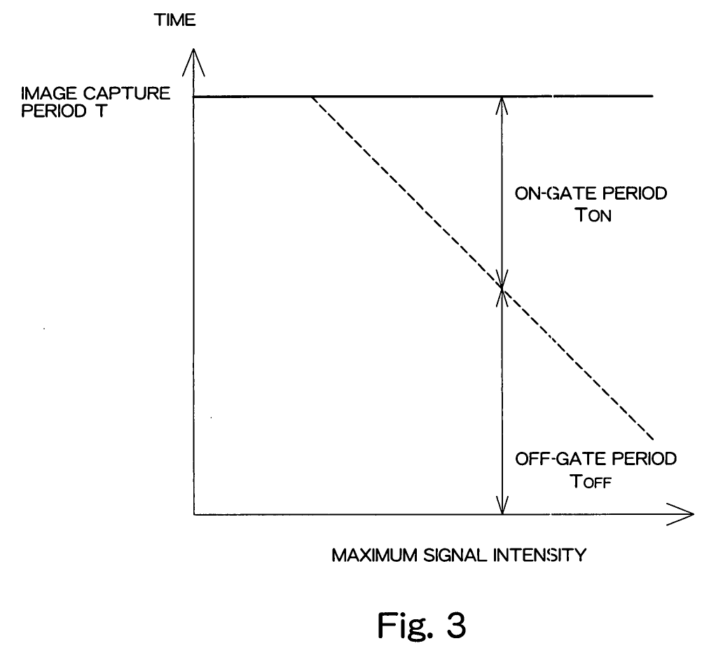

The timing control circuit 204 determines the ratio of the OFF-gate period and the ON-gate period in the image capture period based on the exposure correction signals from the DSP circuit 210. Since the exposure correction signals are output corresponding to the maximum signal intensity in a previous frame, the timing control circuit 204 performs control such that the OFF-gate period T_{OFF} becomes longer as the maximum signal intensity gets smaller and the ON-gate period T_{ON} becomes longer as the maximum signal intensity gets larger based on the exposure correction signals, as in FIG. 3. The control of the image capture period is performed by utilizing the tendency that the maximum signal intensity included in images that are continuously captured does not change significantly.

It should be noted that, when long time has passed from previous image capture or when a sufficient dynamic range needs to be reliably secured, it is preferable that an image of one frame be first captured and output to detect the maximum signal intensity, that setting of the image capture period be made based on this maximum signal intensity, and that actual image capture be performed after this process.

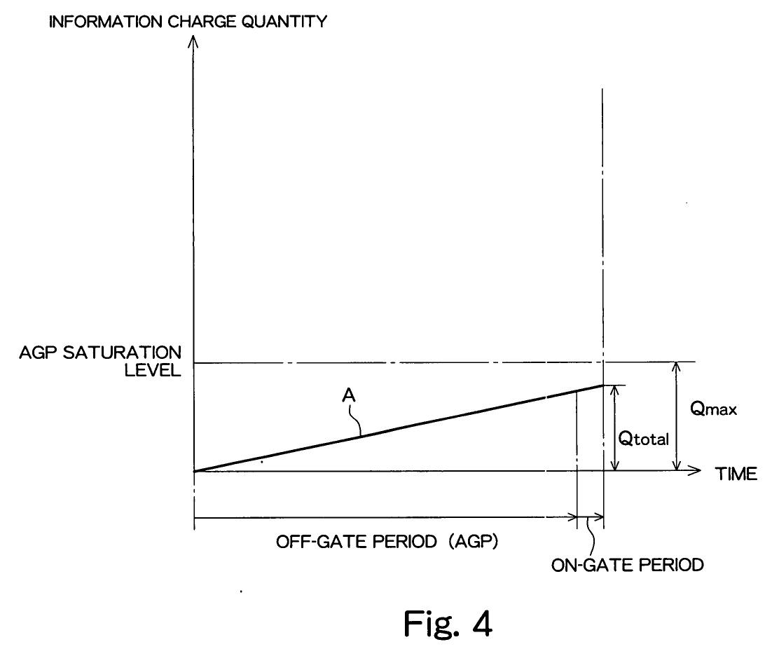

When light incident on the pixels of the image capture section 2i is weak, the information charges (inclination of line A of FIG. 4) stored in the pixels per unit time become smaller as shown in FIG. 4. Information charges Qₜₒₜₐₗ stored becomes smaller than a saturation level Qₘₐₓ of the potential well in the OFF-gate period T_{OFF}, and a necessary dynamic range can be secured even if the ON-gate period T_{ON} is shortened. Furthermore, although, when stored information charges Qₜₒₜₐₗ are small, charges are easily affected by dark current generated in the image capture period T, the affect of dark current on the information charges can be suppressed by setting the ON-gate period T_{ON} to a shorter period.

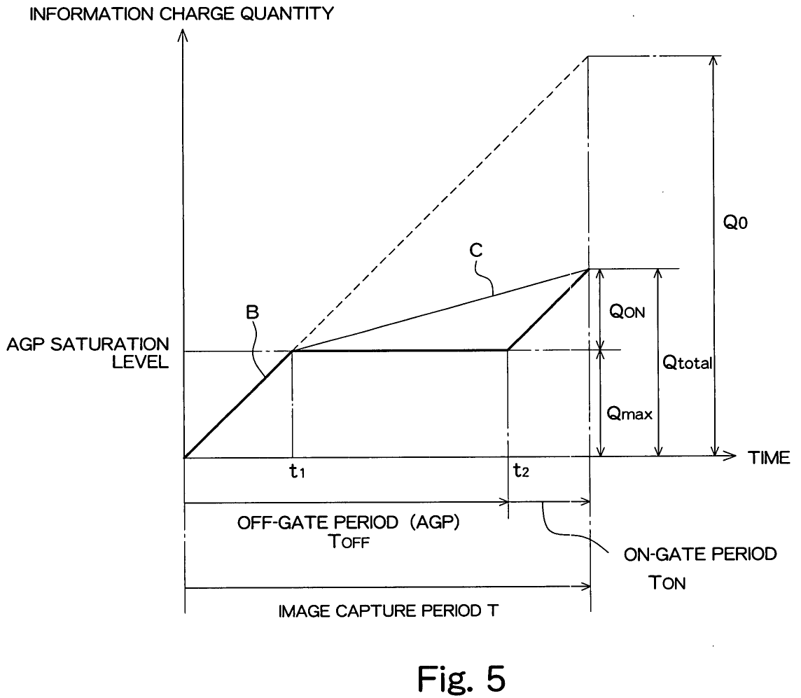

When light made incident to the pixels of the image capture section 2i is intense, the information charges (inclination of line B of FIG. 5) stored in the pixels per unit time become larger as shown in FIG. 5. As a result, the charges may exceed the saturation level of the potential well in the OFF-gate period T_{OFF} at time t₁ in the OFF-gate period T_{OFF}. When the ON-gate period T_{ON} starts at time T₂, the capacitance of the potential well increases and the information charges are stored again. At this point, the storage of information charges at the saturation level Qₘₐₓ or less and the storage of information charges at the saturation level Qₘₐₓ or more show a Knee characteristic.

In an example wherein there is no affect of smear charges generated in the image capture section 2i during transfer, the ratio Q_{ON}/Q₀ between information charge quantity Q_{ON} stored in the ON-gate period T_{ON} and information charges Q₀ becomes equal to ON-gate period T_{ON}/image capture period T, where Q_{ON} denotes information charge quantity obtained by subtracting the saturation level Qₘₐₓ from the total charge quantity Qₜₒₜₐₗ stored, and Q₀ denotes charges that should be stored in the image capture period T when the potential well is not saturated due to its sufficient capacitance. Therefore, it is possible to calculate the information charges Q₀ based on expressions (1) and (2).

$$\begin{matrix}{Q}_{0} = ( {Q}_{total} - {Q}_{max} ) \times \frac{T}{{T}_{ON}} : ( {Q}_{total} ⊳ {Q}_{max} ) & ( 1 ) \\ {Q}_{0} = {Q}_{total} : ( {Q}_{total} \leq {Q}_{max} ) & ( 2 )\end{matrix}$$

By first verifying the saturation level Qₘₐₓ (or an output signal value equivalent to the saturation level Qₘₐₓ) of the potential well in the OFF-gate period T_{OFF}, the information charge quantity Q_{ON} stored in the ON-gate period T_{ON} and the information charges Q₀ that should be stored in the image capture period T when saturation of information charges did not occur using the ON-gate period T_{ON} and the image capture period T can be calculated. When the information charges Q₀ (or an output signal value equivalent to the information charges Q₀) are used in the image signal processing, correct information charge quantity corresponding to the intensity of light can be calculated even if light made incident to the pixels of the image capture section 2i is intense. Accordingly, a sufficient dynamic range can be obtained in image signals.

In a case wherein smear charges are generated in the image capture section 2i during transfer, smear charge component can be removed by using an offset smear removing method. It is assumed that pixels of I-rows (i=1 to I) be arranged parallelly with the transfer direction of the image capture section 2i and information charge quantity Q_{total,i} be stored in the pixel of an i-th row in the image capture period T. In a vertical transfer period, information charges are transferred to the storage section 2s at each transfer cycle Tₜ by one pixel at a time sequentially from the pixel of the first row. At this point, if light shield mechanism such as a mechanical shutter is not provided for the image capture section 2i, smear charges equivalent to a quantity obtained by multiplying information charges corresponding to the intensity of light made incident to the pixels of i-th row by transfer cycle Tₜ/image capture period T are added to the pixels of the i-th row during the transfer cycle Tₜ. This is because the photo-detection intensity of each pixel in the image capture period T and the transfer cycle Tₜ can be regarded as constants. Consequently, the smear component generated in each pixel having passed during the transfer period is superposed to the information charge quantity Q_{total,i} and transferred to the storage section 2s as information charge Q_{out,i}. Meanwhile, as shown below, information charge Q_{0,i} that should be stored in the pixel of the i-th row during the image capture period T can be calculated when the potential well is not saturated due to its sufficient capacitance.

Because information charge Q_{total,1} stored in the pixel of the first row adjacent to the storage section 2s is immediately transferred to the storage section 2s as transfer starts, information charge Q_{total,1} is not affected by smear. Therefore, it is possible to calculate information charge Q_{0,1} using expression (3), when information charge Q_{out,1} exceeds the saturation level Qₘₐₓ. On the other hand, when the information charge Q_{out,1} does not exceed the saturation level Qₘₐₓ, the information charge Q_{out,1} is directly used as the information charge Q_{0,1}.
Q_{0,1}=(Q_{out,1}−Qₘₐₓ)×T/T_{ON}:(Q_{out,1}Qₘₐₓ) (3)
Q_{0,1}=Q_{out,1}:(Q_{out,1}≦Qₘₐₓ) (4)

The information charges Q_{total,2}, Q_{total,3}, . . . Q_{total,I} stored in pixels of the first row and subsequent rows are affected by smear until they are transferred to the storage section 2s. Specifically, in the information charge quantity Q_{out,i}, smear charges equivalent to a quantity, which is obtained by multiplying the information charge quantity (Q_{0,1} to Q_{0,i-1}) corresponding to the intensity of light made incident to pixels of the first row to the (i-1)th row by the quantity of Tₜ/T that is a value obtained by dividing the transfer cycle Tₜ by the image capture period T, is added to the information charge Q_{total,i} stored in the pixel of the i-th row. Consequently, it is possible to calculate the information charge Q_{0,i} sequentially by using expressions (5) and (6).

$$\begin{matrix}{Q}_{0 , i} = \{ ( {Q}_{out , i} - {\sum }_{n = 1}^{i - 1} {Q}_{o , n} \times \frac{{T}_{t}}{T} ) - {Q}_{max} \} \times \frac{T}{{T}_{ON}} : ( {Q}_{out , i} - {\sum }_{n = 1}^{i - 1} {Q}_{o , n} \times \frac{{T}_{t}}{T} ) ⊳ {Q}_{max} & ( 5 ) \\ {Q}_{0 , i} = ( {Q}_{out , i} - {\sum }_{n = 1}^{i - 1} {Q}_{o , n} \times \frac{{T}_{t}}{T} ) : ( {Q}_{out , i} - {\sum }_{n = 1}^{i - 1} {Q}_{o , n} \times \frac{{T}_{t}}{T} ) \leq {Q}_{max} & ( 6 )\end{matrix}$$

Meanwhile, when processing color image signals, sensitivity when information charges exceeding the saturation level are stored is changed with the changes of the ratio between the OFF-gate period and the ON-gate period. Because, as a result, color tone between frames shifts, it is preferable that only signals showing the brightness of pixels be processed in the above-described embodiment when signals of the saturation level or more are output.

As described above, according to the example embodiment of the present invention, by changing the ratio between the OFF-gate period where gates are turned to the OFF state and the ON-gate period where the gates are turned to and ON state depending on the brightness of an object, the affect of dark current is reduced and a sufficient dynamic range can be obtained when processing the output signals. Specifically, the OFF-gate period is made longer when the image of only an object having low brightness is captured to suppress the affect of dark current during image capture. Further, when an object having high brightness is included, the ON-gate period where the gates are turned to the ON state is made longer to sufficiently secure the dynamic range of output signals.

It should be understood that although the above-described embodiment has been described using an example image capture device including the CCD solid image capture element of a frame transfer type, the applicable range of the present invention is not limited to this configuration. The invention can be also applied, for example, to image capture devices provided with an image capture element of another type.

1. An image capture device, comprising:
a solid image capture element that includes pixels, which generate and store information charges corresponding to the intensity of light made incident to the pixels during image capture period, in which said pixels are provided with transfer electrodes, and the element transfers the information charges by applying voltage to said transfer electrodes during transfer period and outputs the charges as image signals corresponding to the charge quantity, wherein
said device includes voltage control means for changing voltage to be applied to said transfer electrodes corresponding to the intensity of light made incident to said pixels to change a saturation level of charges storable in said pixels during image capture.

2. The image capture device according to claim 1, wherein
said voltage control means changes a time ratio between an OFF-gate period, where said transfer electrodes are held in an OFF state to store information charges in said pixels, and an ON-gate period, where at least a part of said transfer electrodes is held in an ON state to store the information charges in said pixels.

3. The image capture device according to claim 2, wherein
said voltage control means performs one image capture while said ON-gate period is provided after said OFF-gate period.

4. The image capture device according to claim 1, wherein
said device includes image signal processing means for removing smear component that has been superposed on the information charge by applying an offset smear removing method to said image signals.

5. A method of controlling an image capture device that comprises a solid image capture element that includes pixels, which generate and store information charges corresponding to the intensity of light made incident to the pixels during image capture period, in which said pixels are provided with transfer electrodes, and the element transfers the information charges by applying voltage to said transfer electrodes during transfer period and outputs the charges as image signals corresponding to the charge quantity, said method comprising the step of:
Voltage controlling step in where voltage to be applied to said transfer electrodes is changed corresponding to the intensity of light made incident to said pixels and a saturation level of charges storable in said pixels during image capture is changed.

6. The method of controlling an image capture device according to claim 5, wherein
a time ratio between an OFF-gate period, where said transfer electrodes are held in an OFF state to store information charges in said pixels, and an ON-gate period, where at least a part of said transfer electrodes is held in an ON state to store the information charges in said pixels, is changed in said step of controlling voltage.

7. A control program product for a computer, which controls an image capture device that comprises a solid image capture element that includes pixels, which generate and store information charges corresponding to the intensity of light made incident to the pixels during image capture period, in which said pixels are provided with transfer electrodes, and the element transfers the information charges by applying voltage to said transfer electrodes during transfer period and outputs the charges as image signals corresponding to the charge quantity,
said control program product causing the computer to function as voltage control means for changing voltage to be applied to said transfer electrodes corresponding to the intensity of light made incident to said pixels, and to function as a device for changing a saturation level of charges storable in said pixels during image capture.
